(19) United States
(12) Patent Application Publication
(10) Pub. No.: US 2022/0309248 A1
(43) Pub. Date: Sep. 29, 2022

(54) METHOD AND SYSTEM FOR PRODUCT KNOWLEDGE FUSION

(71) Applicant: China Academy of Art, Hangzhou (CN)

(72) Inventors: Zheng LIU, Hangzhou (CN); Xin WANG, Hangzhou (CN); Ming SHAO, Hangzhou (CN); Ke ZONG, Hangzhou (CN); Yun WANG, Hangzhou (CN)

(73) Assignee: China Academy of Art, Hangzhou (CN)

(21) Appl. No.: 17/652,205

(22) Filed: Feb. 23, 2022

(30) Foreign Application Priority Data
Mar. 26, 2021 (CN) 202110327074.6

(51) Int. Cl. G06F 40/30; G06F 40/40; G06F 40/279; G06N 5/02; G06Q 30/02

(52) U.S. Cl. CPC G06F 40/30; G06F 40/40; G06F 40/279; G06N 5/022; G06Q 30/0201

(57) ABSTRACT

A method and system for product knowledge fusion are discloses. The method includes following steps: acquiring original data of a product; performing knowledge extraction on the original data of the product to obtain entities, attributes and semantic relationships related to the product; building an entity information knowledge base according to the entities, attributes and semantic relationships related to the products; fusing the semantic relationships and attributes with the entities and matching the entities by adopting a text matching model to obtain original data of the product corresponding to matched entity information; and establishing a knowledge graph of the product according to the matched entity information. The method and system standardize multi-source heterogeneous data with a knowledge fusion method, thus effectively reducing polysemy and unclear references of knowledge caused by different data structures and sources.

### CROSS-REFERENCE TO RELATED APPLICATIONS

This Non-provisional application claims priority under 35 U.S.C. § 119(a) to Chinese Patent Application No. 202110327074.6, filed on 26 Mar. 2021, the entire contents of which are hereby incorporated by reference in its entirety.

### TECHNICAL FIELD

The disclosure relates to a field of deep learning, in particular to a method and a system for product knowledge fusion.

### BACKGROUND ART

In order to assist product designers to conduct product researches and take full advantage of big data, a product design knowledge graph can be constructed to present correlation of products intuitively and efficiently. When constructing the knowledge graph, knowledge often comes from many different data sources. Because of differences in structure and content between the data sources, there are also problems such as polysemy and unclear references when the acquired knowledge is integrated. Therefore, it is necessary to make knowledge fusion processing so as to eliminate ambiguity of references between entities and/or attributes, and standardize multi-source heterogeneous data.

Text matching is an important basic issue in natural language processing, which can be applied to a large number of NLP tasks, such as information retrieval, question answering system, retelling problems, dialogue systems, machine translations, etc., which can be largely abstracted as text matching problems. Traditional text matching techniques include BoW, VSM, TF-IDF, BM25, Jaccord, SimHash and other algorithms, which mainly solve matching problems at a lexical level, or similarity problems at the lexical level. In fact, a matching algorithm based on lexical overlapping has great limitations, including word-meaning limitations, structure limitations and knowledge limitations. This implies that for the text matching tasks, the matching should not only stay at a literal level, but should go deep into a semantic matching level.

### SUMMARY

One of objects of the disclosure is to provide a method and system for product knowledge fusion, which uses semantic text for text matching, thus overcoming shortcomings of word-level matching and improving accuracy of matching.

Another of the objects of the present disclosure is to provide a method and system for product knowledge fusion, which standardize multi-source heterogeneous data with a knowledge fusion method, thus effectively reducing polysemy and unclear references of knowledge caused by different data structures and sources.

Another of the objects of the disclosure is to provide a method and system for product knowledge fusion, in which information including but not limited to a named entity, part of speech, morphology and syntax are added to a term vector for fusion, so that the term vector contains richer semantic information and improves accuracy of knowledge identification.

Another of the objects of the disclosure is to provide a product knowledge fusion method and system, which further extract context of an entity for feature extracting obtain semantic information of the context, and use the semantic information of the context as context of the entity for semantic identifying, which can improve accuracy of meaning identification of the entity in an article.

In order to achieve at least one of the above objects, a product knowledge fusion method is further provided in the present disclosure, which includes following steps:

acquiring, by the processor, original data of a product;

performing, by the processor, knowledge extraction on the original data of the product to obtain entities, attributes and semantic relationships related to the product;

building, by the processor, an entity information knowledge base according to the entities, attributes and semantic relationships related to the products;

fusing, by the processor, the semantic relationships and attributes with the entities, and matching the entities by adopting a text matching model to obtain original data of the product corresponding to matched entity information; and

establishing, by the processor, a knowledge graph of the product according to the matched entity information;

storing the knowledge graph in a memory device.

Responsive to a user request for a product search, searching a database based on the user request the stored knowledge graph and retrieving relevant data. The knowledge graph has a unified structured representation, which contains rich semantic information, attributes and relationships between entities, as well as other rich related information. And because it is a graph data structure, it is convenient to perform various graph related operations. Therefore, the establishment of knowledge graph can improve the efficiency and accuracy of product search. The knowledge graph includes product entity information (color, material, style, etc.), the relationship between products (whether the product material, color, etc. are the same) and other information. This is an advantage that traditional retrieval technology does not have.

According to one of preferred embodiments of the present disclosure, text data in the original data of the product is obtained, and is segmented so as to obtain a keyword of the text data.

According to another of preferred embodiments of the present disclosure, the keyword from segmenting is converted into a word vector, and a named entity, morphology, part of speech corresponding to the keyword and syntactic information of a sentence where the keyword is located are obtained and converted into a feature vector and then input into the word vector for fusion, so as to obtain fused entity information.

According to another of the preferred embodiments of the present disclosure, context of the entity information is acquired, and features of the context are extracted, and a K-Max pooling operation is performed on the entity information and the corresponding context, and pooled feature vectors are spliced, specifically as follows:

Vₑₙₜ_{ₚ}_{ⁱ}=K Max{Conv_{entity}(entₚⁱ)};

V_{ctx}_{ₚ}_{^{i−}}=K Max{Conv_{context}(ctxₚⁱ⁻)};

V_{ctx}_{ₚ}_{ⁱ⁺}=K Max{Conv_{context}(ctxₚⁱ⁺)};

the above three vectors are then spliced into Vₚⁱ=└Vₑₙₜ_{ₚ}_{ⁱ},V_{ctx}_{ₚ}_{^{i−}},V_{ctx}_{ₚ}_{ⁱ⁺}┘;

in which entₚⁱ, ctxₚⁱ⁻ and ctxₚⁱ⁺ respectively represent a i-th named entity, text segments before the entity and text segments after the entity in a sentence P, KMax { } represents the K-Max pooling operation, and Vₑₙₜ_{ₚ}_{ⁱ}, V_{ctx}_{ₚ}_{^{i−}}, and V_{ctx}_{ₚ}_{ⁱ⁺} respectively represent vectors for the entity, texts before the entity and texts after the entity, obtained by a convolutional neural network and a K-Max pooling, and a matched entity information matrix of sentences in different product text data is calculated by a bilinear interpolation method.

According to another of the preferred embodiments of the present disclosure, a Bilinear similarity measurement function is used to calculate the interaction information of two sentences at different positions, which includes following steps:

acquiring position information pᵢ and hᵢ of the two sentences, where pᵢ and hᵢ are converted into vectors Pₚ_{ᵢ} and Pₕ_{ᵢ} respectively;
outputting an interaction matrix according to feature vectors of the two position information:

S_{B}(Pₚ_{ᵢ},pₕ_{ᵢ})=Pₚ_{ᵢ}^{T}MPₕ_{ᵢ}+b;

and further calculating attention interaction of granularity of different text data:

eᵢⱼ=Eᵢ^{p}^{^{T}}Eⱼ^{h}, in which eᵢⱼ∈R^{m×n}

$${α}_{i}^{p} = {\sum }_{j = 1}^{n} \frac{exp ( {e}_{ij} )}{{\sum }_{k = 1}^{n} exp ( {e}_{ik} )} {E}_{j}^{h} ∀ i ∈ [ 1 , 2 , 3 , … , m ] ;$$

$${β}_{j}^{h} = {\sum }_{i = 1}^{m} \frac{exp ( {e}_{ij} )}{{\sum }_{k = 1}^{m} exp ( {e}_{kj} )} {E}_{j}^{p} ∀ j ∈ [ 1 , 2 , 3 , … , n ] ;$$

where eᵢⱼ is dot-product similarity between an i-th word in a product text data P and the j-th word in a product text data H, exp(eᵢₖ) represents normalization processing of eᵢₖ, k is a corresponding text entity word, m is a number of words in the text P, n is a number of words in the text H, exp(eᵢₖ) represents normalization of all words in the text data H to an i-th keyword in the text data P, and eₖⱼ represents normalization of all words in the text data P to a j-th keyword in the text data H, P^{T} is a transpose matrix of a matrix P, and attention expressions of the text data P and H are α^{p} and β^{h} respectively, in which αᵢ^{p} is obtained by weighted summation of each word in the text H, which indicates matching information of the i-th word in the text P and each of the words in the text H; β^{h} is obtained by weighted summation of each word in the text P, which indicates matching information between the j-th word in the text H and each of the words in the text P.

According to another of the preferred embodiments of the present disclosure, local structure information is extracted respectively for word embeddings of the two text data E^{p} and E^{h} using the convolutional neural network, so as to obtain local semantic matrices of two texts respectively:

C^{p}=Wide_CNN(E^{p});

C^{h}=Wide_CNN(E^{h});

in which C^{p}∈R^{m×l×ck}, C^{h}∈R^{n×l×ck}, m and n are the number of words in text data P and text data H, respectively, and ck is a number of kernels, C^{p} is a result of the word embedding E^{p} passing through a wide convolution neural network structure; C^{h} is a result of the word embedding E^{h} passing through the wide convolution neural network structure.

According to another of the preferred embodiments of the present disclosure, the output results C^{h} and C^{p} are subjected to attention interaction calculation, so as to obtain local semantic attention matrices cnn^{P} and cnn^{h} of the text data P and the text data H.

According to another of the preferred embodiments of the present disclosure, self-attention interactions within the texts are calculated respectively, and a calculation formula of the self-attention interaction of the text data P is:

$${SA}_{i}^{p} = {\sum }_{j = 1}^{m} \frac{exp ( {α}_{ij} )}{{\sum }_{k = 1}^{n} exp ( {α}_{kj} )} {E}_{j}^{p} ∀ i , j ∈ [ 1 , 2 , 3 , … , m ] ;$$

in which

$${α}_{iij} = \frac{{\sum }_{i}^{{p}^{T}} {E}_{j}^{p}}{\sqrt{d}} ;$$

where a calculation formula of sub-attention of the text data H is the same as that of the text data P, αᵢⱼ represents attention of a word i and word j in the text P, and is calculated to obtain self-attention interaction results of the two texts.

According to another of the preferred embodiments of the present disclosure, context interaction matrixes, granularity attention interaction matrixes, local semantic attention interaction matrixes and self-attention interaction matrixes of the two text data P and H which are matched with each other are spliced respectively to form new semantic matrices:

N_S^{p}=Concat└α^{p};cnn^{p};SA^{P};S_{B}(Pₚ_{ᵢ},Pₕ_{ᵢ})┘;

N_S^{h}=Concat└β^{h};cnn^{h}SA^{h};S_{B}(Pₚ_{ᵢ},Pₕ_{ᵢ})┘;

the new semantic matrices are respectively input into a BiLSTM network to extract semantic features of the text, which are used to obtain final matching results, and the knowledge graph is constructed according to the final matching results.

In order to achieve at least one of the above objects, a system for product knowledge fusion is further provided in the present disclosure, which applies the above-described method for product knowledge fusion.

In order to achieve at least one of the above objects, a computer-readable storage medium is further provided in the present disclosure, which stores and applies the above-described method for product knowledge fusion.

### BRIEF DESCRIPTION OF THE DRAWINGS

FIG. 1 shows a flow chart of a method for product knowledge fusion according to the present disclosure.

FIG. 2 shows a schematic diagram of a convolution model according to the present disclosure.

FIG. 3 shows a structural diagram of a text matching model according to the present disclosure.

### DETAILED DESCRIPTION

The following description is intended to disclose the present invention so as to enable those skilled in the art to implement the invention. The embodiments in the following description are by way of example only, and other obvious variations will occur to those skilled in the Art. The basic principle of the invention defined in the following description can be applied to other implementations, modified, improved and equivalent schemes and other schemes without departing from the spirit and scope of the utility model.

It should be understood by those skilled in the art that in the disclosure of the present invention, the orientation or positional relationship indicated by the terms “longitudinal”, “transverse”, “upper”, “lower”, “front”, “rear”, “left”, “right”, “vertical”, “horizontal”, “top”, “bottom”, “inner”, “inner” and the like is based on the orientation or positional relationship shown in the drawings, which is only for the convenience of describing the invention and simplifying the description, but does not indicate or imply that the referred device or element must have a specific orientation, be constructed and operated in a specific orientation, and thus the above terms cannot be understood as limiting the invention.

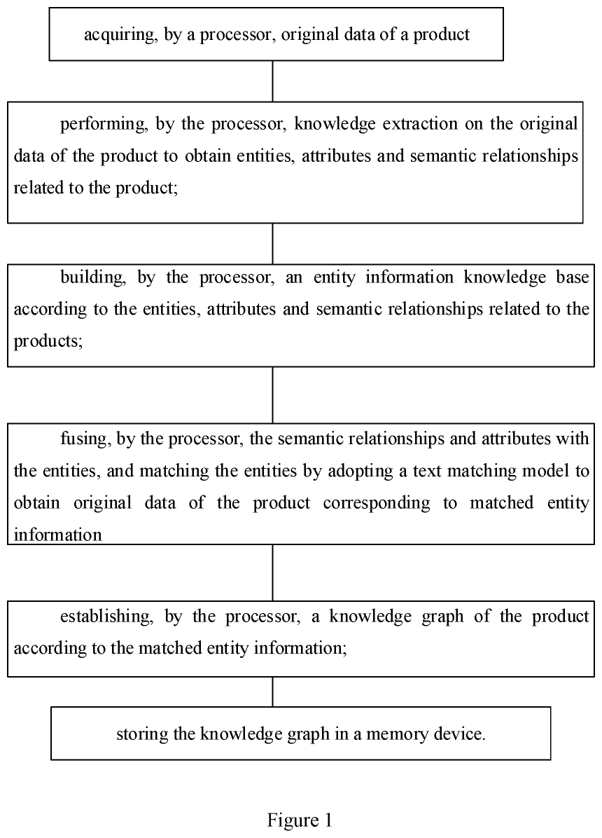

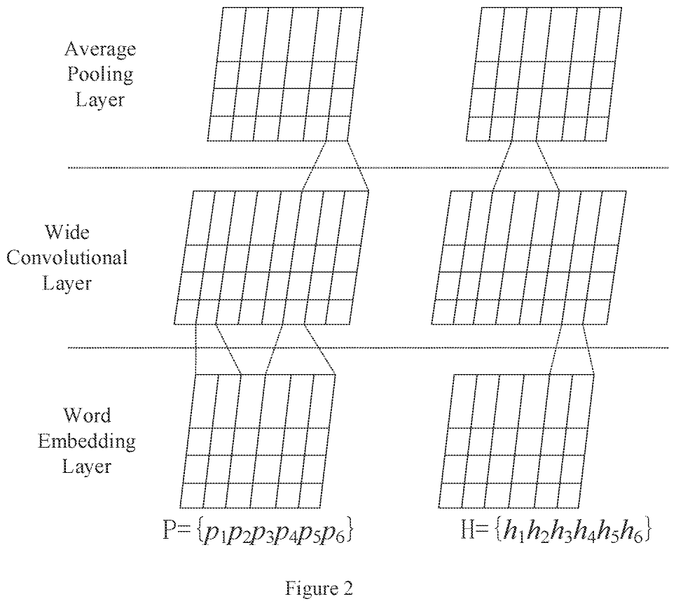

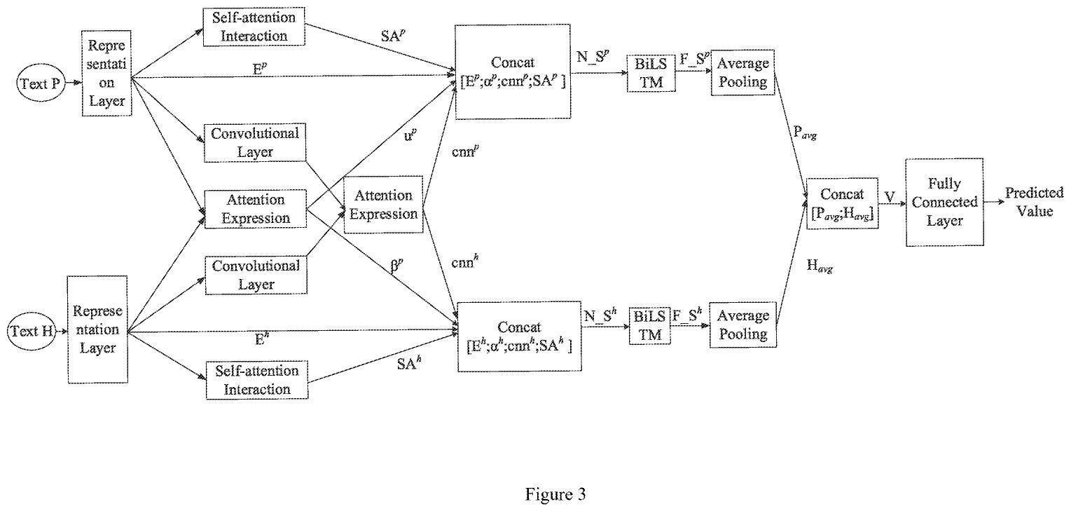

Referring to FIGS. 1-3, a method and system for product knowledge fusion are provided. In the method, semantic features of a product entity are fully introduced for matching, and the semantic features include the granularity, local features and global features of text data, and are fused with context features of the entity in the text data with matching being made using a deep learning algorithm, so that similar text data can be accurately matched, which can be used for product similarity judgment and product knowledge graph construction.

Specifically, the method for product knowledge fusion requires to firstly acquire original text data of the product. The original text data of the product can be acquired by technologies including but not limited to crawler, and then each of the text data is segmented. Because the disclosure is realized by comparing pairwise data, the disclosure takes text data P and text data H as two text data required to be matched, and the two text data respectively come from different products.

According to the disclosure, an existing jieba thesaurus can be used to segment the acquired text data P and the text data H, and the keywords corresponding to the two text data can be obtained respectively. It should be noted that the jieba thesaurus can adopt a high-precision mode, and long words can be segmented again, so as to obtain high-precision keywords.

The two text data is segmented by the thesaurus, and then the keywords from the segmenting are converted into a vector. The Woed2Vect algorithm is preferred in the present disclosure to convert keywords into a corresponding word vector. If the keywords do not appear in a vocabulary, the keywords are randomly initialized. in which word vectors of the text data P and the text data H are:

E^{p}=[E₁^{p},E₂^{p}, . . . ,Eᵢ^{p}, . . . ,Eₘ^{p}]^{T}∀i∈[1,2,3, . . . ,m];

E^{h}=[E₁^{h},E₂^{h}, . . . ,Eⱼ^{h}, . . . ,Eₙ^{h}]^{T}∀j∈[1,2,3, . . . ,n];

in which E^{p} ∈ R^{m×d} E^{h} ∈ R^{n×d} m and n represent numbers of words in product design texts P and H, respectively, and d represents dimension of the word vector. E^{p} and E^{h} represent word vectors of the text data p and the text data h, respectively.

Further, part of speech, morphology of each of the keywords and syntax of the sentence where the keyword is located are acquired. The part of speech, morphology and syntax of sentence where the keyword is located are transformed into a feature vector, in which the part of speech can include but not limited to an adverb, an auxiliary word, a conjunction and a noun, and the morphology includes but not limited to using a noun as a verb, a noun as an adverb, an adjective as a noun, an adjective as a verb, a verb as a noun and a numeral as a verb, verb causative usage, adjective causative usage, noun causative usage, or the like. The syntax includes but is not limited to a declarative sentence, an interrogative sentence, an imperative sentence and an exclamatory sentence.

An existing natural language processing model, such as a NLTK and StanfordNLP model, is used to identify named entities of the two texts, and the named entities are converted into a feature vector into which a feature vector corresponding to the above-described named entities, part of speech, morphology and sentence where the keyword is located are fused. The entity sets of the text data P and the text data H: {entₚⁱ}ᵢ₌₁^{k} and {entₕⁱ}ᵢ₌₁^{l} are obtained after the named entities are identified by the existing model.

Since meaning of the entity is related to the context of the text, in order to better acquire the semantic information represented by the entity, context features of the entity are further extracted in this disclosure, which specifically includes following steps.

Different one-dimensional convolutional neural networks Conv_{entity} and Conv_{context} networks are used to extract features of the named entity and of text segments of the context of the named entity respectively, to obtain a feature vector of the named entity, a feature vector of texts before the entity and a feature vectors of texts after the entity, and the feature vectors of the named entity and the context are input to a K-Max layer for a pooling operation. A formula of the pooling operation is as follows:

Vₑₙₜ_{ₚ}_{ⁱ}=K Max{Conv_{entity}(entₚⁱ)};

V_{ctx}_{ₚ}_{^{i−}}=K Max{Conv_{context}(ctxₚⁱ⁻)};

V_{ctx}_{ₚ}_{ⁱ⁺}=K Max{Conv_{context}(ctxₚⁱ⁺)};

in which Conv_{entity} indicates an one-dimensional convolutional neural network for feature extraction of the named entity, Conv_{context} indicates an one-dimensional convolutional neural network for feature extraction of the named entity's context, entₚⁱ, ctxₚⁱ⁻ and ctxₚⁱ⁺ respectively represent an i-th named entity, text segments before the entity and text segments after the entity in the sentence P. KMax { } indicates a K-Max pooling operation, Vₑₙₜ_{ₚ}_{ⁱ}, V_{ctx}_{ₚ}_{^{i−}} and V_{ctx}_{ₚ}_{ⁱ⁺} respectively represent vector representations of the entity, the texts before the entity and the texts after the entity, obtained by the convolutional neural network and a K-Max pooling. For k feature vectors of the context of the entity in the text data P and one feature vector of the context of the entity in the text H, a Bilinear algorithm (bilinear difference algorithm) is used to calculate an entity matching matrix between the text data P and the text data H. A text position pᵢ of the entity in the text data P and a text position hᵢ of the entity in the text data H are respectively transformed into vector representations: Pₚ_{ᵢ} and Pₕ_{ᵢ}, the Bilinear algorithm is further adopted to establish interactive information based on the text positions: S_{B}(Pₚ_{ᵢ},Pₕ_{ᵢ})=Pₚ_{ᵢ}^{T}MPₕ_{ᵢ}+b; in which M is a weight matrix of interaction in different dimensions, b is a linear partial parameter, S_{B} (Pₚ_{ᵢ}, Pₕ_{ᵢ}) indicates an interaction matrix of the text position, and Pₚ_{ᵢ}^{T} represents a transpose matrix of Pₚ_{ᵢ}. dot-product similarity is calculated between an i-th keyword in the product text data P and a j-th word in the text data:

eᵢⱼ=Eᵢ^{p}^{^{T}}Eⱼ^{h};

in which eᵢⱼ∈R^{m×n}, R^{m×n} represents a matrix in a corresponding dimension, and the dimension is respectively related to the text data P and the word number M, N of the text data, Eᵢ^{PT} represents a matrix of the text data P at the i-th word and the matrix P is transposed, and Eⱼ^{h} represents a matrix of the text data H at the j-th word, context attention matrixs α^{p} and β^{h} of the text data P and the text data H are further obtained:

$${α}_{i}^{p} = {\sum }_{j = 1}^{n} \frac{exp ( {e}_{ij} )}{{\sum }_{k = 1}^{n} exp ( {e}_{ik} )} {E}_{j}^{h} ∀ i ∈ [ 1 , 2 , 3 , … , m ] ;$$

$${β}_{j}^{h} = {\sum }_{i = 1}^{m} \frac{exp ( {e}_{ij} )}{{\sum }_{k = 1}^{m} exp ( {e}_{kj} )} {E}_{j}^{p} ∀ j ∈ [ 1 , 2 , 3 , … , n ] ;$$

a denominator part exp(eᵢₖ) represents normalization processing of eᵢₖ to concentrate the results in a same interval, the denominator indicates dot-product of all words in the text H with the i-th word in the text P which is subjected to a numerical normalization and summation operation, exp(eᵢₖ) represents normalization processing of eᵢₖ, k refers to a corresponding text entity word, m is the number of words in the text P, n is the number of words in the text H, exp(eᵢₖ) represents normalization of all words in the text data H to an i-th keyword in the text data P, and eₖⱼ represents normalization of all words in the text data P to a j-th keyword in the text data H. The attention α^{p} and β^{h} of the text data P and the text data H is text attention based on the granularity, respectively. Attention based on local features is further calculated in the disclosure, in which the local features of the text required to be acquired, and are converted into a feature vector, and local attention interaction of the text is calculated by the above-mentioned calculation method. It should be noted that an attention calculation method based on local granularity is the same as a calculation method based on granularity, which will not be repeatedly described here in detail.

In order to effectively utilize semantic information in the text, a wide convolution neural network is further adopted in the disclosure to embed vectors E^{P} and E into words, so as to extract local structural features respectively to form a text semantic matrix.

C^{p}=Wide_CNN(E^{p});

C^{h}=Wide_CNN(E^{h});

in which C^{p}∈R^{m×l×ck}, C^{h}∈R^{n×l×ck}, m and n are numbers of words in the text data P and H respectively, l is a dimension parameter and ck is a number of kernels, C^{p} is a result of the word embedding vector E^{p} passing through the wide convolution neural network structure and C^{h} is a result of the word embedding vector E^{h} passing through the wide convolution neural network structure. Attention interaction calculation is performed on data of local structure features of the text passing through the wide convolution neural network output in a coding layer, so as to respectively obtain final local semantic attention matrixes of the text data P and the text data H: cnn^{p}, cnn^{h}.

In order to capture dependence of the text on a long distance, a word order and context information of the text are taken into account to obtain deep semantic information, it is necessary to interact within the text to find correlation within the text sequence. Taking the text P as an example, self-attention representation SA^{p} of P is calculated:

$${SA}_{i}^{p} = {\sum }_{j = 1}^{m} \frac{exp ( {α}_{ij} )}{{\sum }_{k = 1}^{n} exp ( {α}_{kj} )} {E}_{j}^{p} ∀ i , j ∈ [ 1 , 2 , 3 , … , m ]$$

in which

$${α}_{iij} = \frac{{\sum }_{i}^{{p}^{T}} {E}_{j}^{p}}{\sqrt{d}}$$

is attention of word i and word j in the text data P, and d is a dimension of the word vector. Similarly, self-attention representation SA^{h} of H can be obtained.

In the disclosure, various interaction information are further fused, and a fusion method includes following steps.

Through multiperspective interaction matrix splicing calculation, it can be obtained that context interaction matrixes, granularity attention interaction matrixes, local semantic attention interaction matrixes and self-attention interaction matrixes are spliced respectively to form new semantic matrices:

N_S^{p}=Concat└α^{p};cnn^{p};SA^{P};S_{B}(Pₚ_{ᵢ},Pₕ_{ᵢ})┘;

N_S^{h}=Concat└β^{h};cnn^{h}SA^{h};S_{B}(Pₚ_{ᵢ},Pₕ_{ᵢ})┘;

The new semantic matrices are input into a BiLSTM network so as to extract text semantic features, N_S^{p} represents a new semantic matrix of the text data P and N_S^{h} represents a new semantic matrix of the text data H.

It is worth mentioning that there are three gating units in LSTM network: an input gate, a forget gate, a output gate, as well as two memory units: a long-term memory and a short-term memory. At time t, a calculation method of three gate units and two memory units of the LSTM is as follows:

the input gate: Iₜ=σ(Wᵢ·[hₜ₋₁,xₜ]+bᵢ);

the forget gate: Fₜ=σ(W_{f}·[hₜ₋₁,xₜ]+b_{f});

the output gate: Oₜ=σ(Wₒ·[hₜ₋₁,xₜ]+bₒ);

the Long-term memory: Cₜ=Fₜ*Cₜ₋₁=Iₜ*[tan h(W_{c}·[hₜ₋₁,xₜ]+b_{c})];

the Short-term memory: hₜ=Oₜ*tan h(Cₜ);

in which hₜ₋₁ is an output of a hidden layer at time t-1, X is an input at a current time, Wᵢ, W_{c}, W_{f}, Wₒ represents different weight matrices, bᵢ, b_{f}, b_{c}, bₒ represents different offset matrices, σ represents a sigmiod function, and hₜ represents an output of an LSTM unit at time t.

Final text semantic representation is expressed as:

F_Sₜ^{p}=BiLSTM(F_Sₜ₋₁^{p},N_S^{p});

F_Sₜ^{h}=BiLSTM(F_Sₜ₋₁^{h},N_S^{h});

in which F_Sₜ^{p}, F_Sₜ^{h} are semantic representations of the two texts encoded by the BiLSTM at time t respectively.

Pavg=Avg_Pooling(N_S^{p});

Havg=Avg_Pooling(F_S^{h});

V=Concat[Pavg;Havg];

A spliced semantic vector V is introduced into a classifier of a multilayer perceptron with a relu activation function for classification. The whole network is end-to-end trained in back propagation using a is softmax cross entropy loss function to obtain the final matched entity information.

Particularly, according to embodiments of the present disclosure, the process described above with reference to the flowchart may be implemented as a computer software program. For example, an embodiment of the present disclosure includes a computer program product including a computer program carried on a computer readable medium, and the computer program contains program code for executing the method shown in the flowchart. In such an embodiment, the computer program can be downloaded and installed from the network through a communication part, and/or installed from a removable medium. When the computer program is executed by a central processing unit (CPU), the above functions defined in the method of the present application are performed. It should be noted that the above-mentioned computer-readable medium in this application can be a computer-readable signal medium or a computer-readable storage medium or any combination of the above two. The computer-readable storage medium can be, for example, but not limited to, an electronic, magnetic, optical, electromagnetic, infrared, or semiconductor system, apparatus, or device, or any combination of the above. More specific examples of the computer-readable storage media may include, but are not limited to, electrical connections with one or more wire segments, portable computer disks, hard disks, random access memories (RAM), read-only memories (ROM), erasable programmable read-only memories (EPROM or flash memories), optical fibers, portable compact disk read-only memories (CD-ROMs), optical storage devices, magnetic storage devices, or any suitable combination of the above. In this application, the computer-readable storage medium can be any tangible medium containing or storing a program, which can be used by or in combination with an instruction execution system, apparatus or device. In this application, the computer-readable signal medium may include a data signal propagated in baseband or as a part of a carrier wave in which the computer-readable program code is carried. This propagated data signal can take various forms, including but not limited to an electromagnetic signal, an optical signal or any suitable combination of the above. A computer-readable signal medium can also be any computer-readable medium other than a computer-readable storage medium, which can send, propagate or transmit a program for use by or in connection with an instruction execution system, apparatus or device. The program code contained in the computer readable medium can be transmitted with any suitable medium, including but not limited to a wireless segment, an electric wire segment, a fiber optic cable, RF, etc., or any suitable combination of the above.

The flowcharts and block diagrams in the drawings illustrate the architecture, functions and operations of possible implementations of systems, methods and computer program products according to various embodiments of the present invention. In this regard, each block in the flowchart or block diagram may represent a module, a program segment or a part of code containing one or more executable instructions for implementing specified logical functions. It should also be noted that in some alternative implementations, the functions noted in the blocks may also occur in a different order from that noted in the drawings. For example, two blocks in succession may actually be executed in substantially parallel, or they may sometimes be executed in a reverse order, depending on the functions involved. It should also be noted that each block in the block diagrams and/or flowcharts, along with combinations of blocks in the block diagrams and/or flowcharts, can be implemented with dedicated hardware-based systems that perform specified functions or operations, or can be implemented with combinations of dedicated hardware and computer instructions.

It can be understood that the term “a or an” should be understood as “at least one” or “one or more”, that is, in one embodiment, the number of an element may be one, while in other embodiments, the number of the element may be multiple, and the term “an” cannot be understood as limiting the number.

It should be understood by those skilled in the art that the embodiments of the present invention described above and shown in the drawings are only taken as examples and do not limit the present invention; the function and structural principle of the invention have been shown and explained in the embodiments; any variation and modification can be made to the embodiments of the invention without departing from the principle.

What is claimed is:

1. A product knowledge fusion method, comprising following steps:
acquiring, by a processor, original data of a product;
performing, by the processor, knowledge extraction on the original data of the product to obtain entities, attributes and semantic relationships related to the product;
building, by the processor, an entity information knowledge base according to the entities, attributes and semantic relationships related to the products;
fusing, by the processor, the semantic relationships and attributes with the entities, and matching the entities by adopting a text matching model to obtain original data of the product corresponding to matched entity information;
establishing, by the processor, a knowledge graph of the product according to the matched entity information; and
storing the knowledge graph in a memory device.

2. The product knowledge fusion method according to claim 1, wherein text data in the original data of the product is obtained, and is segmented so as to obtain a keyword of the text data.

3. The product knowledge fusion method according to claim 1, wherein the keyword from segmenting is converted into a word vector, and a named entity, morphology, part of speech corresponding to the keyword and syntactic information of a sentence where the keyword is located are obtained and converted into a feature vector and then input into the word vector for fusion, so as to obtain fused entity information.

4. The product knowledge fusion method according to claim 1, wherein context of the entity information is acquired, and features of the context are extracted, and a K-Max pooling operation is performed on the entity information and the corresponding context, and pooled feature vectors are spliced, specifically as follows:
Vₑₙₜ_{ₚ}_{ⁱ}=K Max{Conv_{entity}(entₚⁱ)};
V_{ctx}_{ₚ}_{^{i−}}=K Max{Conv_{context}(ctxₚⁱ⁻)};
V_{ctx}_{ₚ}_{ⁱ⁺}=K Max{Conv_{context}(ctxₚⁱ⁺)};
the above three vectors are then spliced into Vₚⁱ=└Vₑₙₜ_{ₚ}_{ⁱ},V_{ctx}_{ₚ}_{^{i−}},V_{ctx}_{ₚ}_{ⁱ⁺}┘;
in which entₚⁱ, ctxₚⁱ⁻ and ctxₚⁱ⁺ respectively represent a i-th named entity, text segments before the entity and text segments after the entity in a sentence P, KMax { } represents the K-Max pooling operation, and Vₑₙₜ_{ₚ}_{ⁱ}, V_{ctx}_{ₚ}_{^{i−}}, and V_{ctx}_{ₚ}_{ⁱ⁺} respectively represent vectors for the entity, texts before the entity and texts after the entity, obtained by a convolutional neural network and a K-Max pooling, and a matched entity information matrix of sentences in different product text data is calculated by a bilinear interpolation method.

5. The product knowledge fusion method according to claim 4, wherein a Bilinear similarity measurement function is used to calculate the interaction information of two sentences at different positions, which comprises following steps:
acquiring position information pᵢ and hᵢ of the two sentences, where Pᵢ and hᵢ are converted into vectors Pₚ_{ᵢ} and Pₕ_{ᵢ} respectively;
outputting an interaction matrix according to feature vectors of the two position information:
S_{B}(Pₚ_{ᵢ},pₕ_{ᵢ})=Pₚ_{ᵢ}^{T}MPₕ_{ᵢ}+b;
and further calculating attention interaction of granularity of different text data:
$${e}_{ij} = {E}_{i}^{{p}^{T}} {E}_{j}^{h} , in which {e}_{ij} ∈ {R}^{m \times n}$$
$${α}_{i}^{p} = {\sum }_{j = 1}^{n} \frac{exp ( {e}_{ij} )}{{\sum }_{k = 1}^{n} exp ( {e}_{ik} )} {E}_{j}^{h} ∀ i ∈ [ 1 , 2 , 3 , … , m ] ;$$
$${β}_{j}^{h} = {\sum }_{i = 1}^{m} \frac{exp ( {e}_{ij} )}{{\sum }_{k = 1}^{m} exp ( {e}_{kj} )} {E}_{j}^{p} ∀ j ∈ [ 1 , 2 , 3 , … , n ] ;$$
where eᵢⱼ is dot-product similarity between an i-th word in a product text data P and the j-th word in a product text data H, exp(eᵢₖ) represents normalization processing of eᵢₖ, k is a corresponding text entity word, m is a number of words in the text H, n is a number of words in the text P, exp(eᵢₖ) represents normalization of all words in the text data H to an i-th keyword in the text data P, and eₖⱼ represents normalization of all words in the text data P to a j-th keyword in the text data H, P^{T} is a transpose matrix of a matrix P, and attention expressions of the text data P and H are α^{p} and β^{h} respectively, in which αᵢ^{p} is obtained by weighted summation of each word in the text H, which indicates matching information of the i-th word in the text P and each of the words in the text H; β^{h} is obtained by weighted summation of each word in the text P, which indicates matching information between the j-th word in the text H and each of the words in the text P.

6. The product knowledge fusion method according to claim 5, wherein local structure information is extracted respectively for word embeddings of the two text data E^{p} and E^{h} using the convolutional neural network, so as to obtain local semantic matrices of two texts respectively:
C^{p}=Wide_CNN(E^{p});
C^{h}=Wide_CNN(E^{h});
in which C^{p}∈R^{m×l×ck}, C^{h}∈R^{n×l×ck}, m and n are the number of words in text data P and text data H, respectively, and ck is a number of kernels, C^{p} is a result of the word embedding E^{p} passing through a wide convolution neural network structure; C^{h} is a result of the word embedding E^{h} passing through the wide convolution neural network structure.

7. The product knowledge fusion method according to claim 6, wherein the output results C^{h} and C^{p} are subjected to attention interaction calculation, so as to obtain local semantic attention matrices cnn^{p} and cnn^{h} of the text data P and the text data H.

8. The product knowledge fusion method according to claim 7, wherein self-attention interactions within the texts are calculated respectively, and a calculation formula of the self-attention interaction of the text data P is:
$${SA}_{i}^{p} = {\sum }_{j = 1}^{m} \frac{exp ( {α}_{ij} )}{{\sum }_{k = 1}^{n} exp ( {α}_{kj} )} {E}_{j}^{p} ∀ i , j ∈ [ 1 , 2 , 3 , … , m ] ;$$
in which
$${α}_{iij} = \frac{{\sum }_{i}^{{p}^{T}} {E}_{j}^{p}}{\sqrt{d}} ;$$
wherein a calculation formula of sub-attention of the text data H is the same as that of the text data P so as to obtain self-attention interaction results of the two texts.

9. The product knowledge fusion method according to claim 8, wherein context interaction matrixes, granularity attention interaction matrixes, local semantic attention interaction matrixes and self-attention interaction matrixes of the two text data P and H which are matched with each other are spliced respectively to form new semantic matrices:
N_S^{p}=Concat└α^{p};cnn^{p};SA^{P};S_{B}(Pₚ_{ᵢ},Pₕ_{ᵢ})┘;
N_S^{h}=Concat└β^{h};cnn^{h}SA^{h};S_{B}(Pₚ_{ᵢ},Pₕ_{ᵢ})┘;
the new semantic matrices are respectively input into a BiLSTM network to extract semantic features of the text, which are used to obtain final matching results, and the knowledge graph is constructed according to the final matching results.

10. A system for product knowledge fusion, comprising:
a processor,
a non-transitory computer-readable medium having stored thereon instructions to cause the process to execute a method, the method comprising:
acquiring, by a processor, original data of a product;
performing, by the processor, knowledge extraction on the original data of the product to obtain entities, attributes and semantic relationships related to the product;
building, by the processor, an entity information knowledge base according to the entities, attributes and semantic relationships related to the products;
fusing, by the processor, the semantic relationships and attributes with the entities, and matching the entities by adopting a text matching model to obtain original data of the product corresponding to matched entity information; and
establishing, by the processor, a knowledge graph of the product according to the matched entity information;
storing the knowledge graph in a memory device.

11. A non-transitory computer-readable having stored thereon instructions to cause a computer to execute a method, the method comprising: acquiring, by a processor, original data of a product;
performing, by the processor, knowledge extraction on the original data of the product to obtain entities, attributes and semantic relationships related to the product;
building, by the processor, an entity information knowledge base according to the entities, attributes and semantic relationships related to the products;
fusing, by the processor, the semantic relationships and attributes with the entities, and matching the entities by adopting a text matching model to obtain original data of the product corresponding to matched entity information; and
establishing, by the processor, a knowledge graph of the product according to the matched entity information;
storing the knowledge graph in a memory device.
